(19) United States
(12) Patent Application Publication
(10) Pub. No.: US 2023/0237605 A1
(43) Pub. Date: Jul. 27, 2023

(54) TRUSTABILITY ANALYZING SYSTEM, TRUSTABILITY ANALYZING METHOD, AND NON-TRANSITORY COMPUTER-READABLE MEDIUM

(71) Applicant: NEC Corporation, Minato-ku, Tokyo (JP)

(72) Inventors: Masahiro TANI, Tokyo (JP); Kazufumi Kojima, Tokyo (JP); Keisuke Ikeda, Tokyo (JP)

(73) Assignee: NEC Corporation, Minato-ku, Tokyo (JP)

(21) Appl. No.: 18/011,618

(22) PCT Filed: Jun. 24, 2020
(86) PCT No.: PCT/JP2020/024803

§ 371 Date: Dec. 20, 2022

(51) Int. Cl. G06Q 50/26; G06Q 50/00

(52) U.S. Cl. CPC G06Q 50/265; G06Q 50/01; G06V 40/16

(57) ABSTRACT

A trustability analyzing system (100) includes: a friend list acquisition unit (111) configured to acquire, via a network, person attribute information of a holder of an account that is subject to determination; a friend information acquisition unit (112) configured to acquire, via the network, a list of friend accounts of the account that is subject to determination; an attribute information acquisition unit (113) configured to acquire, based on the list of friend accounts, information about the friend via the network; a person attribute estimation unit (121) configured to estimate, based on the information about the friends, person attributes of the holder of the account that is subject to determination; a distance calculation unit (122) configured to calculate a distance between the person attribute information acquired by the person attribute acquisition means and the person attributes estimated by the person attribute estimation means; and a trust level calculation unit (123) configured to calculate, based on the distance calculated by the distance calculation means, a trust level of the account that is subject to determination.

### TECHNICAL FIELD

The present disclosure relates to a trustability analyzing system, a trustability analyzing method, and a non-transitory computer-readable medium.

### BACKGROUND ART

In recent years, the number of users of multiple SNS (Social Networking Service) has been increasing. Many companies use SNS information such as profile information and posted information for their marketing and recommendation systems. Further, the aforementioned SNS information is utilized in crime investigations and the like conducted by law enforcement agencies.

In the case of crimes that exploit cyber space (e.g. terrorism, illegal drug trafficking, acts of fraud, etc.), one person uses several different SNS and Dark Webs. Criminals use fake accounts with spoofed profile information on SNS and Dark Webs.

Non-Patent Literature 1 discloses a technique of determining whether or not an account is a fake account based on the features specific to the fake account. To be more specific, Non-Patent Literature 1 discloses a technique of determining whether or not an account is a fake account based on the features of the account such as details about the account (holder) have been left blank, there are not many accounts on the Followers list, there are many accounts on the Following list, trending topics are regularly and continuously retweeted (in the case of a Bot), and a default profile/background image is used.

### CITATION LIST

### Non-Patent Literature

Non-Patent Literature 1: Ersahin et al, “Twitter Face Account Detection,” IEEE UBMK' 17

### SUMMARY OF INVENTION

### Technical Problem

The method disclosed in Non-Patent Literature 1 has a problem in that an account can be created based on information over which the imposter has control and the imposter can avoid oneself from being detected as using a fake account.

An object of the present disclosure is to provide, in view of the problem mentioned above, a trustability analyzing system, a trustability analyzing method, and a non-transitory computer-readable medium that are adapted to determine whether or not a target account is a fake account.

### Solution to Problem

A trustability analyzing system according to an example embodiment includes:

person attribute acquisition means for acquiring, via a network, person attribute information of a holder of an account that is subject to determination;

friend list acquisition means for acquiring, via the network, a list of friend accounts of the account that is subject to determination;

friend information acquisition means for acquiring, via the network, information about friends based on the list of friend accounts;

person attribute estimation means for estimating, based on the information about the friends, person attributes of the holder of the account that is subject to determination;

distance calculation means for calculating a distance between the person attribute information acquired by the person attribute acquisition means and the person attributes estimated by the person attribute estimation means; and

trust level calculation means for calculating, based on the distance calculated by the distance calculation means, a trust level of the account that is subject to determination.

A trustability analyzing method according to another example embodiment includes:

a person attribute acquisition step of acquiring, via a network, person attribute information of a holder of an account that is subject to determination;

a friend list acquisition step of acquiring, via the network, a list of friend accounts of the account that is subject to determination;

a friend information acquisition step of acquiring, via the network, information about friends based on the list of friend accounts;

a person attribute estimation step of estimating, based on the information about the friends, person attributes of the holder of the account that is subject to determination;

a distance calculation step of calculating a distance between the person attribute information acquired in the person attribute acquisition step and the person attributes estimated in the person attribute estimation step; and

a trust level calculation step of calculating, based on the distance calculated in the distance calculation step, a trust level of the account that is subject to determination.

A non-transitory computer readable-medium according to further another example embodiment for causing a computer to execute:

a person attribute acquisition step of acquiring, via a network, person attribute information of a holder of an account that is subject to determination;

a friend list acquisition step of acquiring, via the network, a list of friend accounts of the account that is subject to determination;

a friend information acquisition step of acquiring, via the network, information about friends based on the list of friend accounts;

a person attribute estimation step of estimating, based on the information about the friends, person attributes of the holder of the account that is subject to determination;

a distance calculation step of calculating a distance between the person attribute information acquired in the person attribute acquisition step and the person attributes estimated in the person attribute estimation step; and

a trust level calculation step of calculating, based on the distance calculated in the distance calculation step, a trust level of the account that is subject to determination.

### Advantageous Effects of Invention

According to a trustability analyzing system, a trustability analyzing method, and a non-transitory computer-readable medium of the present disclosure, it is possible to determine whether or not a target account is a fake account.

### BRIEF DESCRIPTION OF DRAWINGS

FIG. 1 is a block diagram showing a configuration of a trustability analyzing system according to a first example embodiment;

FIG. 2 is a flowchart showing an example of an operation of the trustability analyzing system according to the first example embodiment;

FIG. 3 is a block diagram showing an example of calculating distance (similarity) between person attributes in the trustability analyzing system according to the first example embodiment; and

FIG. 4 is a block diagram showing a configuration of a trustability analyzing system according to a second example embodiment.

### EXAMPLE EMBODIMENT

### First Example Embodiment

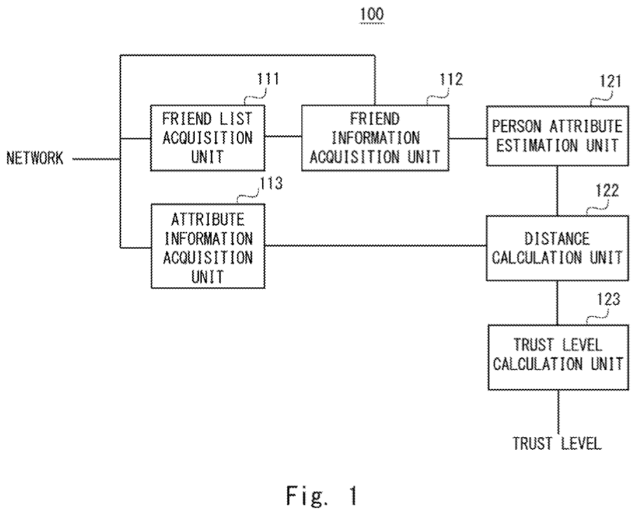

Hereinbelow, example embodiments of the present disclosure will be described with reference to the drawings. FIG. 1 is a block diagram showing a configuration of a trustability analyzing system according to a first example embodiment. In FIG. 1, a trustability analyzing system 100 includes a friend list acquisition unit 111, a friend information acquisition unit 112, an attribute information acquisition unit 113, a person attribute estimation unit 121, a distance calculation unit 122, and a trust level calculation unit 123.

The friend list acquisition unit 111 acquires a list of friend accounts of the account that is subject to determination. Then, the friend list acquisition unit 111 outputs the acquired list of friend accounts to the friend information acquisition unit 112.

The friend information acquisition unit 112 acquires, based on the list of friend accounts, the person attribute information of a friend of the account that is subject to determination. For example, the friend information acquisition unit 112 acquires, as person attribute information of a friend, the profile and the posted information on the friend account. Then, the friend information acquisition unit 112 outputs, to the person attribute estimation unit 121, the acquired person attribute information of the friend.

The attribute information acquisition unit 113 acquires the person attribute information of the holder of the account that is subject to determination. For example, the attribute information acquisition unit 113 acquires the person attribute information described in the profile etc. of the account that is subject to determination.

For example, the friend list acquisition unit 111, the friend information acquisition unit 112, and the attribute information acquisition unit 113 are configured of communication circuits connected to a network.

The person attribute estimation unit 121 estimates, based on the person attribute information of friends, the person attribute of the account that is subject to determination. Then, the person attribute estimation unit 121 outputs the estimated person attribute information to the distance calculation unit 122.

The distance calculation unit 122 calculates the distance (similarity) between the person attribute information acquired by the aforementioned person attribute acquisition means and the person attributes estimated by the aforementioned person attribute estimation means. For example, the distance calculation unit 122 calculates the distance (similarity) between the acquired person attribute information and the estimated person attributes for the information of the same category. Specifically, the distance (similarity) between the place of residence as indicated in the profile of the account that is subject to determination, and the place of residence estimated from the friend information of the account that is subject to determination may be calculated.

Further, the category for calculating the distance (similarity) may be at least one of the difference in age, gender, income, education (e.g.: the distance (similarity) between the rank of school and the academic field one majored in), profession (such as blue-collar or white-collar, the distance (similarity) between industries), or the demographic attributes such as the family structure. The calculation may be performed by a method based on the distance (similarity) between the academic fields which the account holders majored in or the distance (similarity) between the industries in which the account holders work (e.g. a rate of enrollment for different academic field or a rate of change of profession to another industry (the transition rate)). Further, category for which the distance (similarity) is to be calculated may be at least one of the difference in the taste and preference (e.g.: indoors person/outdoors person) and in the psychographic attributes such as the purchasing tendency.

The trust level calculation unit 123 calculates, based on the distance (similarity) calculated by the distance calculation unit 122, the trust level of the account that is subject to determination. The trust level is a numerical index obtained as in the calculation of the distance (similarity). Further, the trust level calculation unit 123 may calculate the trust level of the account from the result of comparison of the distance (similarity) calculated by the distance calculation unit 122 with a threshold value as to whether the calculated distance (similarity) is greater than the threshold value.

For example, the person attribute estimation unit 121, the distance calculation unit 122, and the trust level calculation unit 123 are each configured of a processor that performs information processing.

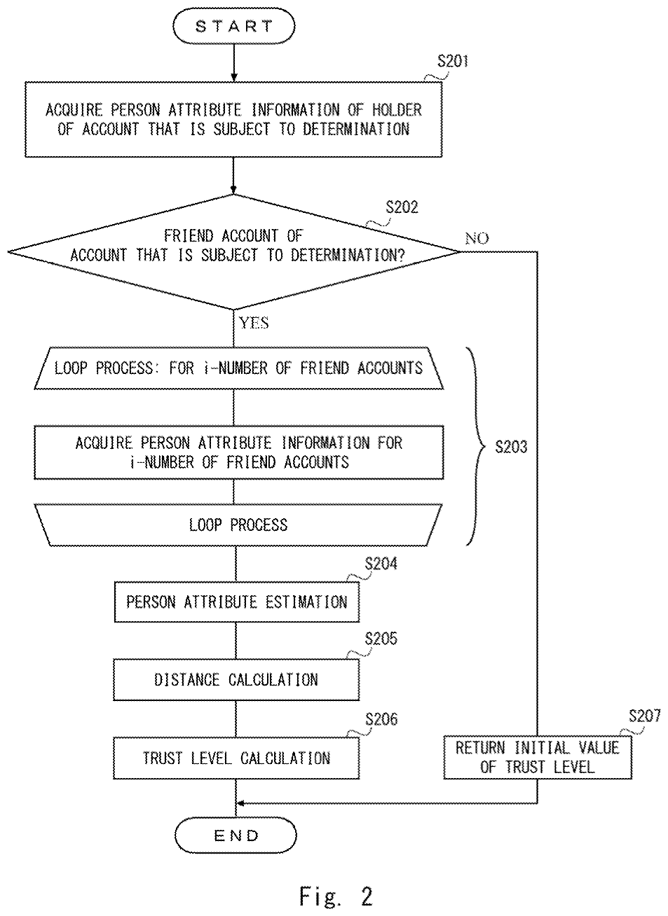

As described above, the trustability analyzing system 100 calculates the trust level of the account that is subject to determination. Next, the operation of the trustability analyzing system 100 will be described. FIG. 2 is a flowchart showing an example of the operation of the trustability analyzing system according to the first example embodiment.

First, in Step S201, the attribute information acquisition unit 113 acquires the person attributes of the holder of the account that is subject determination. Then, the process proceeds to Step S202.

In Step S202, the friend list acquisition unit 111 acquires the friend accounts of the account that is subject to determination. Then, it is determined whether or not there is the friend account of the account that is subject to determination. If there is the friend account of the account that is subject to determination, the process proceeds to Step S203. If there is no friend account of the account that is subject to determination, the process proceeds to Step S207.

In Step S203, the friend list acquisition unit 111 acquires the person attribute information of each friend account of the account that is subject to determination. For example, the friend list acquisition unit 111 acquires the person attribute information of a friend account for i-number of friend accounts. Note that the friend list acquisition unit 111 may collectively acquire person attribute information of all friend accounts.

In Step S204, the person attribute estimation unit 121 estimates the person attributes of the account that is subject to determination based on the person attribute information of the friend. For example, the person attribute estimation unit 121 estimates the person attributes of the account that is subject to determination based on the acquired person attribute information of all the friends. Then, the process proceeds to Step S205.

In Step S205, the distance calculation unit 122 calculates the distance (similarity) between person attributes, the one between the acquired person attribute information of the account that is subject to determination and the estimated person attribute of the account that is subject to determination. Then, the process proceeds to Step S206.

In Step S206, the trust level calculation unit 123 calculates, based on the distance (similarity) between the person attributes, the trust level of the account that is subject to determination. Then, the process ends.

In Step S207, the trust level calculation unit 123 returns the initial value of the trust level of the account that is to subject determination. Then, the processing ends.

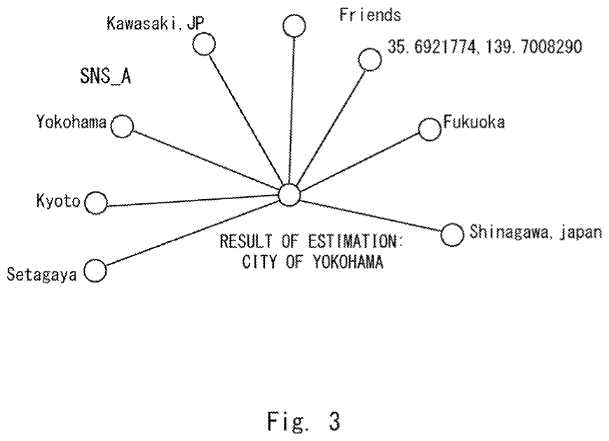

Through the operations described above, the trustability analyzing system 100 calculates the trust level of the account that is subject to determination. Next, the distance (similarity) between the person attributes in the trustability analyzing system 100 will be described. FIG. 3 is a block diagram showing an example of calculating distance (similarity) between person attributes in the trustability analyzing system according to the first example embodiment.

As shown in FIG. 3, the place of residence of the account holder of the account that is subject to determination is estimated from the acquired information about the place of residence of the holders of the friend accounts. In the example shown in FIG. 3, it is estimated, from the physical distance between the places of residence of the account holders, that the place of residence of the holder of the account that is subject to determination is the city of Yokohama. Then, in the case where the account holder's place of residence as mentioned in the profile of the account that is subject to determination is the city of Yokohama, since the physical distance between the account holder's place of residence mentioned in the profile of the account that is subject to determination and the estimated place of residence of the account holder, which the city of Yokohama, is close to each other (or the same), it is determined that the trustability of the information of the account that is subject to determination is high. Further, in the case where the place of residence mentioned in the profile of the account that is subject to determination is the city of Sapporo, since the physical distance between the place of residence mentioned in the profile of the account that is subject to determination and the estimated place of residence, which the city of Yokohama, is far from each other, it is determined that the trustability of the information of the account that is subject to determination is low.

As described above, in the trustability analyzing system according to the first example embodiment, it is possible to determine whether or not the account that is subject to determination is actually a fake account by calculating the distance (similarity) between person attributes, the one between the person attribute information estimated from the friend account of the account that is subject to determination and the person attribute information acquired from profile of the account that is subject to determination.

### Second Example Embodiment

In a second example embodiment, an example of applying the trustability analyzing system according to the first example embodiment in performing account verification based on the similarities regarding the information posted on a friend account will be described. Specifically, in the second example embodiment, an example of determining whether Account A and Account B originate from the same person will be described.

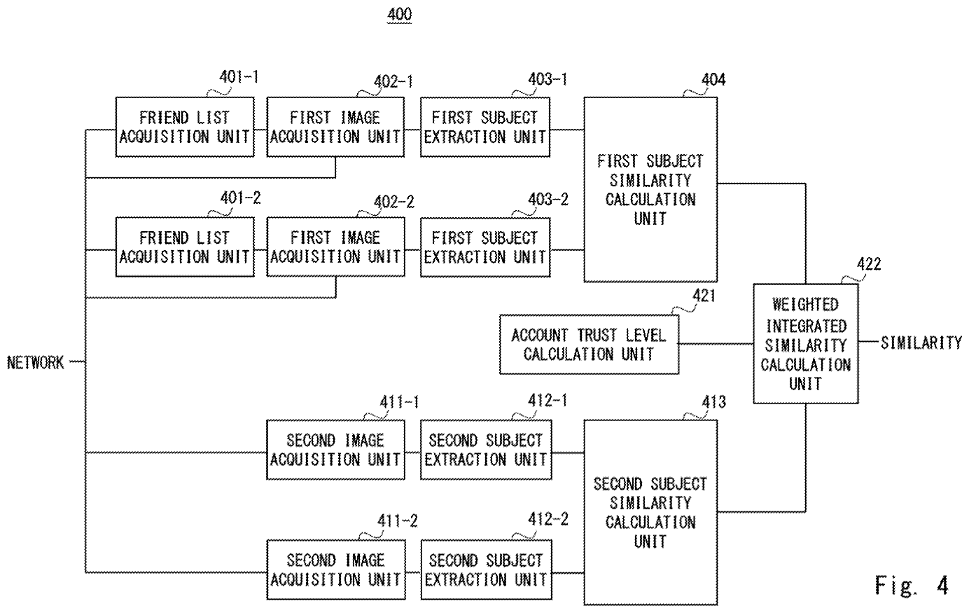

FIG. 4 is a block diagram showing a configuration of a trustability analyzing system according to the second example embodiment. In FIG. 4, a trustability analyzing system 400 includes friend list acquisition units 401-1 and 401-2, first image acquisition units 402-1 and 402-2, first subject extraction units 403-1 and 403-2, a first subject similarity calculation unit 404, second image acquisition units 411-1 and 411-2, second subject extraction units 412-1 and 412-2, a second subject similarity calculation unit 413, an account trust level calculation unit 421, and a weighted integrated similarity calculation unit 422. The example in FIG. 4 is an example of calculating the similarity between the subject of Account A and the subject of Account B.

The friend list acquisition unit 401-1 acquires the list of friend accounts that are related to Account A. Accounts that are related to Account A are, for example, accounts that are included in the list of friend accounts of Account A, accounts that have exchanged messages (conversations) with Account A, and the like. Then, the friend list acquisition unit 401-1 outputs the acquired list of friend accounts to the first image acquisition unit 402-1.

In a similar manner, the friend list acquisition unit 401-2 acquires the list of friend accounts that are related to Account B. Then, the friend list acquisition unit 401-2 outputs the acquired list of friend accounts to the first image acquisition unit 402-2.

The first image acquisition unit 402-1 acquires, based on the list of friend accounts of Account A, images posted on the friend account of Account A. The images posted on the friend account refer to all the images that are uploaded (shared, linked, etc.) including the profile image and the like. Then, the first image acquisition unit 402-1 outputs the acquired images to the first subject extraction unit 403-1.

In a similar manner, the first image acquisition unit 402-2 acquires, based on the list of friend accounts of Account B, images posted on the friend account of Account B. Then, the first image acquisition unit 402-2 outputs the acquired images to the first subject extraction unit 403-2.

The first subject extraction unit 403-1 extracts the subject from the images acquired by the first image acquisition unit 402-1. For example, the first subject extraction unit 403-1 extracts the subject by image recognition techniques such as face recognition, object recognition, or the like. Then, the first subject extraction unit 403-1 outputs the extracted images of the subject to the first subject similarity calculation unit 404.

In a similar manner, the first subject extraction unit 403-2 extracts the subject from the images acquired by the first image acquisition unit 402-2. Then, the first subject extraction unit 403-2 outputs the extracted images of the subject to the first subject similarity calculation unit 404.

The first subject similarity calculation unit 404 calculates the similarity between the subject in the images extracted by the first subject extraction unit 403-1 and the subject in the images extracted by the first subject extraction unit 403-2. For example, the first subject similarity calculation unit 404 calculates the similarity between the above subjects from the physical characteristics of the subjects in the images of the subjects. For example, the physical characteristics refer to soft biometric information. Specifically, the physical characteristics may include hair color, body shape, color of clothing, accessories worn, and the like. The calculation of the similarity between the subject of Account A and the subject of Account B may be performed by using the similarities (such as the additive average of similarities) calculated by directly comparing the images of the subject of Account A with the images of the subject of Account B using the image recognition technique, or by using the histogram consistency. Then, the first subject similarity calculation unit 404 outputs the calculated similarities to the weighted integrated similarity calculation unit 422.

The second image acquisition unit 411-1 acquires the images posted on Account A. Then, the second image acquisition unit 411-1 outputs the acquired images to the second subject extraction unit 412-1.

In a similar manner, the second image acquisition unit 411-2 acquired images posted on Account B. Then, the second image acquisition unit 411-1 outputs the acquired images to the second subject extraction unit 412-2.

The second subject extraction unit 412-1 extracts the subject from the images acquired by the second image acquisition unit 411-1. Then, the second subject extraction unit 412-1 outputs the extracted images of the subject to the second subject similarity calculation unit 413.

In a similar manner, the second subject extraction unit 412-2 extracts the subject from the images acquired by the second image acquisition unit 411-2. Then, the second subject extraction unit 412-2 outputs the extracted images of the subject to the second subject similarity calculation unit 413.

The second subject similarity calculation unit 413 calculates the similarities between the images of the subject extracted by the second subject extraction unit 412-1 and the images of the subject extracted by the second subject extraction unit 412-2. Then, the second subject similarity calculation unit 413 outputs the calculated similarities to the weighted integrated similarity calculation unit 422. The second subject similarity calculation unit 413 may calculate the similarities using the same method as that used by the first subject similarity calculation unit 404 to calculate the similarities.

The account trust level calculation unit 421 calculates the trust level of Account A and the trust level of Account B by the same method as that used in the trustability analyzing system according to the first example embodiment. Then, the account trust level calculation unit 421 outputs the calculated trust levels of Account A and Account B to the weighted integrated similarity calculation unit 422.

The weighted integrated similarity calculation unit 422 performs weighted integration of similarities based on the trust levels of Account A and Account B. In the case where the trust levels of Account A and Account B are high, the weighted integrated similarity calculation unit 422 places importance on the similarities calculated from Account A and Account B themselves (i.e., the information from the second subject similarity calculation unit 413). Further, in the case where the trust levels of Account A and Account B are low, the weighted integrated similarity calculation unit 422 gives importance to the similarities calculated from the friend accounts of Account A and Account B (i.e., information from a first subject similarity calculation unit 414).

Specifically, if the trust level of Account A is defined as a, the trust level of Account B is defined as b (0≤a, b≤1), the similarities between the subject of Account A and the subject of Account B calculated from Account A and Account B themselves are defined as S0, and the similarities calculated from the friend accounts of Account A and Account B are defined as S1, the weighted integrated similarity calculation unit 422 may calculate the weighted integrated similarities from the expression a×b×S0+(1−a×b)×S1.

Then, based on the aforementioned-calculated weighted integrated similarities, it can be determined as to whether or not Account A and Account B originate from the same person.

According to the trustability analyzing system according to the second example embodiment, by weighting the similarities originated from the accounts and the similarities originated from the friend accounts by the trust levels of the accounts and calculating the similarities, it is possible to determine whether or not a plurality of accounts originate from the same person.

Note that in the aforementioned second example embodiment, the trustability analyzing system calculates the similarities between the subjects from the images of the subjects but the similarities between the subjects can be calculated from any information about the person attributes. Specifically, people, objects (e.g.: cars), places, and topics (e.g.: animation) in images are extracted, and then the similarities between the extracted subjects commonly found in the images (the frequency of appearance in the images) in Account A and Account B may be calculated. Further, the information used for the similarity calculation may not be limited to images, and may also be video. Further, information used for the similarity calculation may be voices (of the speaker etc.) included in the video or keywords (such as the name, the location, etc.) included in the posted text.

Note that the present disclosure is not limited to the aforementioned example embodiments and be changed as appropriate as without departing from the gist of the present disclosure. For example, the structural elements of may be distributed among a plurality of devices and connected through communication lines to exchange information. Alternatively, all of the structural elements may be mounted on one device.

As described above, the present disclosure has been described with reference to the example embodiments but it is not to be limited to any one of them. The configuration and the details of the present disclosure can be changed in various ways within the scope of the present disclosure that can be understood by a person skilled in in the art.

In the above example embodiments, the present disclosure has been described as a hardware configuration, but the present disclosure is not limited thereto. The present disclosure can also be realized by causing a CPU (Central Processing Unit) execute a computer program.

The program can be stored and provided to a computer using various types of non-transitory computer readable media. Non-transitory computer readable media include various types of tangible storage media. Examples of non-transitory computer readable media include magnetic storage media (such as floppy disks, magnetic tapes, hard disk drives,), optical magnetic storage media (such as magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory)). The program may be provided to a computer using various types of transitory computer readable media. Examples of transitory computer readable media include electric signals, optical signals, and electromagnetic waves. Transitory computer readable media can provide the program to a computer via a wired communication line such as electric wires and optical fibers or a wireless communication line.

Further, in the aforementioned example embodiments, a part of or the whole structural elements may be realized in the Cloud. Further, the aforementioned example embodiments, may be realized through a distributed network in which the structural elements are distributed.

### REFERENCE SIGNS LIST

100, 400 TRUSTABILITY ANALYZING SYSTEM
111 FRIEND LIST ACQUISITION UNIT
112 FRIEND INFORMATION ACQUISITION UNIT
113 ATTRIBUTE INFORMATION ACQUISITION UNIT
121 PERSON ATTRIBUTE ESTIMATION UNIT
122 DISTANCE CALCULATION UNIT
123 TRUST LEVEL CALCULATION UNIT
401-1, 401-2 FRIEND LIST ACQUISITION UNIT
402-1, 402-2 FIRST IMAGE ACQUISITION UNIT
403-1, 403-2 FIRST SUBJECT EXTRACTION UNIT
404 FIRST SUBJECT SIMILARITY CALCULATION UNIT
411-1, 411-2 SECOND IMAGE ACQUISITION UNIT
412-1, 421-2 SECOND SUBJECT EXTRACTION UNIT
413 SECOND SUBJECT SIMILARITY CALCULATION UNIT
414 SUBJECT SIMILARITY CALCULATION UNIT
421 ACCOUNT TRUST LEVEL CALCULATION UNIT
422 INTEGRATED SIMILARITY CALCULATION UNIT

What is claimed is:

1. A trustability analyzing system comprising:
at least one memory configured to store instructions; and
at least one processor configured to execute the instructions to:
acquire, via a network, person attribute information of a holder of an account that is subject to determination;
acquire, via the network, a list of friend accounts of the account that is subject to determination;
acquire, via the network, information about friends based on the list of friend accounts;
estimate, based on the information about the friends, person attributes of the holder of the account that is subject to determination;
calculate a distance between the person attribute information attributes; and
calculate, based on the distance, a trust level of the account that is subject to determination.

2. The trustability analyzing system according to claim 1, wherein the at least one processor is further configured to calculate the distance between information of the same category.

3. The trustability analyzing system according to claim 1, wherein the at least one processor is further configured to:
calculate the trust level of each of a plurality of accounts that are subject to determination;
calculate first similarities based on information originating from the friend accounts of the plurality of accounts that are subject to determination;
calculate second similarities based on information originating from the plurality of accounts that are subject to determination; and
calculate weighted integrated similarities by weighting the first similarities and the second similarities by the trust levels of the accounts.

4. The trustability analyzing system according to claim 3, wherein the at least one processor is further configured to:
acquire a friend account that is related to the plurality of accounts that are subject to determination,
acquire first person attribute information of a holder of the friend account that is related to the plurality of accounts that are subject to determination,
extract information about features of the holder of the friend account from the first person attribute information,
acquire second person attribute information of holders of the plurality of accounts that are subject to determination, and
extract information about features of the holders of the plurality of accounts that are subject to determination from the second person attribute information.

5. A trustability analyzing method performed by a computer comprising:
acquiring, via a network, person attribute information of a holder of an account that is subject to determination;
acquiring, via the network, a list of friend accounts of the account that is subject to determination;
acquiring, via the network, information about friends based on the list of friend accounts;
estimating, based on the information about the friends, person attributes of the holder of the account that is subject to determination;
calculating a distance between the person attribute information and the person attributes; and
calculating, based on the distance, a trust level of the account that is subject to determination.

6. A non-transitory computer readable-medium that stores a program for causing a computer to execute:
acquiring, via a network, person attribute information of a holder of an account that is subject to determination;
acquiring, via the network, a list of friend accounts of the account that is subject to determination;
acquiring, via the network, information about friends based on the list of friend accounts;
estimating, based on the information about the friends, person attributes of the holder of the account that is subject to determination;
calculating a distance between the person attribute information and the person attributes; and
calculating, based on the distance, a trust level of the account that is subject to determination.
